(19) United States
(12) Patent Application Publication
(10) Pub. No.: US 2014/0347376 A1
(43) Pub. Date: Nov. 27, 2014

(54) GRAPHICS SERVER AND METHOD FOR MANAGING STREAMING PARAMETERS

(71) Applicant: Nvidia Corporation, Santa Clara, CA (US)

(72) Inventors: Kenneth Tateno, Santa Clara, CA (US); Rahul Gowda, Santa Clara, CA (US); Venkatesh Dadge, Andhra Pradesh (IN); Thomas Meier, Santa Clara, CA (US)

(21) Appl. No.: 13/911,907

(22) Filed: Jun. 6, 2013

Related U.S. Application Data
(60) Provisional application No. 61/827,245, filed on May 24, 2013.

(51) Int. Cl. G06T 1/20; H04L 29/08

(52) U.S. Cl. CPC G06T 1/20; H04L 67/10
USPC 345/522; 709/219

(57) ABSTRACT

A graphics server and method for managing streaming parameters. One embodiment of the graphics server includes: (1) a real-time bandwidth estimator (RBE) configured to generate a bandwidth estimate for a network over which a rendered scene is transmittable, (2) a quality-of-service (QoS) manager configured to generate streaming parameters based on the bandwidth estimate, and (3) a graphics processing unit (GPU) configured to employ the streaming parameters to at least partially prepare the rendered scene for transmission.

### CROSS-REFERENCE TO RELATED APPLICATION

This application claims the benefit of U.S. Provisional Application Ser. No. 61/827,245, filed by Tateno, et al., on May 24, 2013, entitled “Graphics Server and Method for Managing Streaming Parameters,” commonly assigned with this application and incorporated herein by reference.

### TECHNICAL FIELD

This application is directed, in general, to remote computer graphics processing and, more specifically, to managing streaming parameters based on real-time network bandwidth estimates.

### BACKGROUND

The utility of personal computing was originally focused at an enterprise level, putting powerful tools on the desktops of researchers, engineers, analysts and typists. That utility has evolved from mere number-crunching and word processing to highly programmable, interactive workpieces capable of production level and real-time graphics rendering for incredibly detailed computer aided design, drafting and visualization. Personal computing has more recently evolved into a key role as a media and gaming outlet, fueled by the development of mobile computing. Personal computing is no longer resigned to the world's desktops, or even laptops. Robust networks and the miniaturization of computing power have enabled mobile devices, such as cellular phones and tablet computers, to carve large swaths out of the personal computing market.

Mobile computing has transformed conventional notions of information accessibility and media dissemination. Network enabled devices are the new norm, connecting a wide variety of devices over a variety of networks. This has led to a proliferation of conventional, or “mainstream” content, as well as non-conventional, amateur or home-made content. Going forward, not only will this content be available on virtually any mobile device, in addition to conventional outlets, but mobile devices can play the role of a media hub, gaining access to a plethora of content and forwarding it, or “pushing it out,” to one or more display devices, including televisions, computer monitors, projectors or any device capable of receiving, decoding and displaying streamed content. While typically thought of as clients, mobile devices, and more generally, virtually any computing device can play the role of a “media server.”

In a typical server-client remote graphics processing arrangement, graphics content is stored, retrieved and rendered on a server. Frames of rendered content are then captured and encoded, generally at a frame rate that is either specified by a managing device or is simply part of a configuration. Captured and encoded frames are then packetized and transmitted over a network to a client as a video stream (often including audio). The client simply decodes the video stream and displays the content. Such a “thin-client” application can be easily portable to a variety of platforms.

As mobile computing continues to evolve with the growing focus on content accessibility and dissemination, the role of mobile devices will continue to expand. Typical client server boundaries will continue to fade and more people will rely on mobile devices as their client and server, depending on the content of interest.

### SUMMARY

One aspect provides a graphics server. In one embodiment, the server includes: (1) a real-time bandwidth estimator (RBE) configured to generate a bandwidth estimate for a network over which a rendered scene is transmittable, (2) a quality-of-service (QoS) manager configured to generate streaming parameters based on the bandwidth estimate, and (3) a graphics processing unit (GPU) configured to employ the streaming parameters to at least partially prepare the rendered scene for transmission.

Another aspect provides a method of managing streaming parameters for transmitting a rendered scene over a network. In one embodiment, the method includes: (1) employing a real-time bandwidth estimate for the network in determining the streaming parameters, (2) preparing the rendered scene according to the streaming parameters, and (3) packetizing and transmitting the rendered scene over the network.

Yet another aspect provides a graphics server. In one embodiment, the server includes: (1) a communication subsystem having: (1a) a network interface controller (NIC) couplable to a network and operable to transmit packets describing a rendered scene over the network, and (1b) a real-time bandwidth estimator (RBE) coupled to the NIC and configured to generate a bandwidth estimate for the network, (2) a QoS manager configured to generate streaming parameters based on the bandwidth estimate, and (3) a GPU having: (3a) a graphics renderer operable to render the rendered scene according to the streaming parameters, (3b) a frame capturer configured to capture frames of the rendered scene according to the streaming parameters, and (3c) an encoder configured to encode the frames according to the streaming parameters, thereby preparing the rendered scene for packetizing and transmission.

### BRIEF DESCRIPTION

Reference is now made to the following descriptions taken in conjunction with the accompanying drawings, in which:

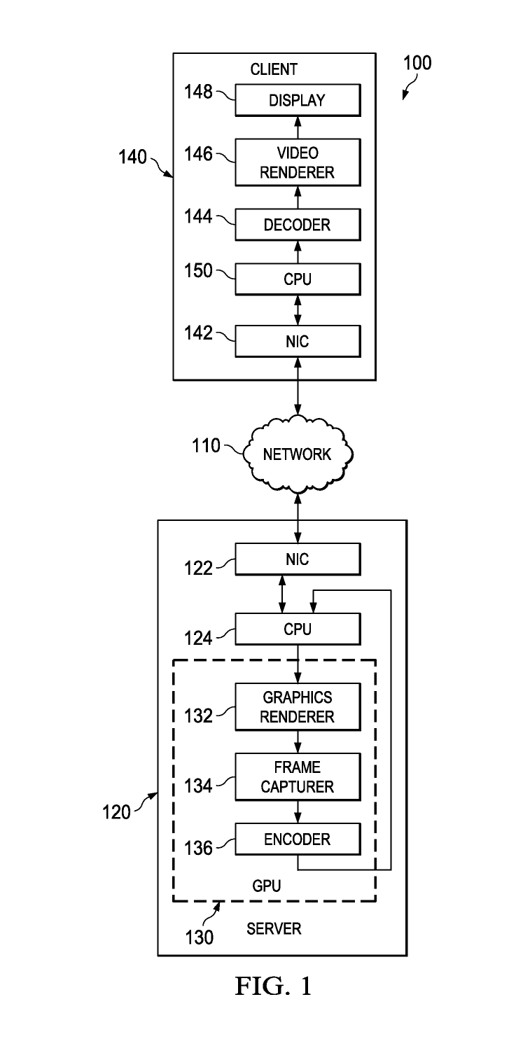

FIG. 1 is a block diagram of one embodiment of a server-client remote graphics processing system;

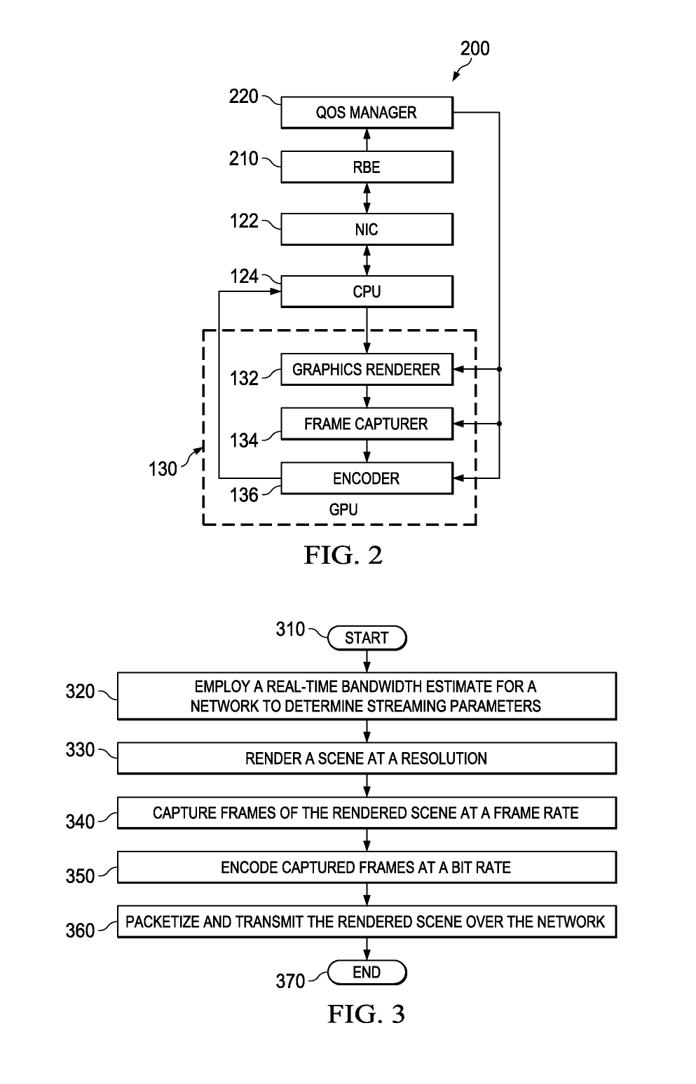

FIG. 2 is a block diagram of one embodiment of a graphics server; and

FIG. 3 is a flow diagram of one embodiment of a method for managing streaming parameters for transmitting a rendered scene over a network.

### DETAILED DESCRIPTION

Major limitations of remote graphics processing are latency and the unpredictable network conditions that bring it about. Latency is induced by a variety of network conditions, including: network bandwidth constraints and fluctuations, packet loss over the network, increases in packet delay and fluctuations in packet delay from the server to the client, which manifest on the client as jitter. Latency in video streaming can be devastating to the streaming experience. Latency and network conditions that induce latency can often be overcome by pre-encoding the streaming media, buffering the stream on the receiving end, or both. While latency is an important aspect of the streaming experience, the apparent fidelity of the video stream to the client is plagued by the same network conditions. Fidelity is a measure of the degree to which a displayed image or video stream corresponds to the ideal. An ideal image mimics reality; its resolution is extremely high, and it has no compression, rendering or transmission artifacts. An ideal video stream is a sequence of ideal images presented with no jitter and at a frame rate so high that it, too, mimics reality. Thus, a higher-resolution, higher-frame-rate, less-artifacted, lower-jitter video stream has a higher fidelity than one that has lower resolution, a lower frame rate, contains more artifacts or is more jittered.

Latency and fidelity are essentially the client's measures of the streaming experience. However, from the perspective of the server, the combination of latency and fidelity are components of quality-of-service (QoS). A QoS system, often a server, is tasked with managing QoS for its clients. The goal is to ensure an acceptable level of latency and fidelity, the streaming experience, is maintained under whatever network conditions arise and for whatever client device subscribes to the service.

The management task involves collecting network data and evaluating the network conditions between the server and client. Traditionally, the client performs that evaluation and dictates back to the server the changes to the video stream it desires. Just as the role of server has opened up to a growing variety of computing devices, the variety of client devices has also exploded. The level of sophistication in client devices has diminished significantly, requiring merely the ability to decode and display a video stream. Consequently, QoS systems relying on client provided network data are challenged by the trend toward these thin clients. Many thin client devices do not collect the necessary network data, and not all network communication protocols support that level of feedback to the server. It is realized herein that graphics servers would benefit from being freed of their dependency on client supplied network data. It is further realized herein that servers can use real-time bandwidth estimation to drive QoS management.

The goal of QoS management is typically to conserve network bandwidth when bandwidth is scarce, and, when bandwidth is available, to improve the fidelity of the transmitted video, which typically consumes more bandwidth. QoS management achieves this goal by generating streaming parameters that, when used on the server, impact the bandwidth required to transmit, or stream the video. The server uses the streaming parameters as it prepares the video stream for packetizing and transmission. This preparation typically includes rendering a scene, capturing frames of the rendered scene, and encoding the captured frames.

One example of a streaming parameter is the resolution at which a graphics renderer renders a scene. Rendering at a higher resolution typically requires more bandwidth to transmit, as the rendering generates more data at higher resolutions. Rendering at a lower resolution can conserve bandwidth. Higher resolution scenes are generally perceived as having higher fidelity.

Another example of a streaming parameter is the frame rate. The frame rate is the rate at which frame capturing occurs and is generally expressed as a frequency. Frame capturing generally involves copying a rendered scene into a buffer for further processing. This process typically occurs automatically on a clock, or at the frame rate. The frame rate, from a client's perspective, is the rate at which the on-screen content is updated, which is often independent of the rendering process. Streaming at a higher frame rate requires transmitting more frames over a given period of time, which adds to network congestion. Reducing the frame rate conserves bandwidth. Streaming video at a higher frame rate is generally perceived as higher fidelity. Conversely, a lower frame rate would generally be perceived as lower fidelity.

Yet another example of a streaming parameter is the bit rate at which captured frames of the video stream are encoded. The bit rate is essentially the rate at which data is transmitted. Increasing the bit rate consumes more bandwidth, and bandwidth is conserved by decreasing the bit rate, generally at the cost of fidelity. Streaming video at a higher bit rate is generally perceived as higher fidelity.

Before describing various embodiments of the graphics server and method for managing streaming parameters introduced herein, a remote graphics processing system within which the graphics server and method may be embodied or carried out will be described.

FIG. 1 is a block diagram of one embodiment of a server-client remote graphics processing system 100. System 100 includes a network 110 through which a server 120 and a client 140 communicate. Server 120 represents the central repository of content, processing and rendering resources. Client 140 is a consumer of that content and those resources. In certain embodiments, server 120 is freely scalable and has the capacity to provide that content and those services to many clients simultaneously by leveraging parallel and apportioned processing and rendering resources. In addition to any limitations on the power, memory bandwidth or latency of server 120, the scalability of server 120 is limited by the capacity of network 110 in that above some threshold of number of clients, scarcity of network bandwidth requires that service to all clients degrade on average.

Server 120 includes a network interface card (NIC) 122, a central processing unit (CPU) 124 and a GPU 130. Upon an election on server 120, or in certain embodiments, upon request from Client 140, graphics content is recalled from memory via an application executing on CPU 124. As is convention for graphics applications, games for instance, CPU 124 reserves itself for carrying out high-level operations, such as determining position, motion and collision of objects in a given scene. From these high level operations, CPU 124 generates rendering commands that, when combined with the scene data, can be carried out by GPU 130. For example, rendering commands and data can define scene geometry, lighting, shading, texturing, motion, and camera parameters for a scene.

GPU 130 includes a graphics renderer 132, a frame capturer 134 and an encoder 136. Graphics renderer 132 executes rendering procedures according to the rendering commands generated by CPU 124, yielding a stream of frames of video for the scene. Those raw video frames are captured by frame capturer 134 and encoded by encoder 136. Encoder 134 formats the raw video stream for packetizing and transmission, possibly employing a video compression algorithm such as the H.264 standard arrived at by the International Telecommunication Union Telecommunication Standardization Sector (ITU-T) or the MPEG-4 Advanced Video Coding (AVC) standard from the International Organization for Standardization/International Electrotechnical Commission (ISO/IEC). Alternatively, the video stream may be encoded into Windows Media Video® (WMV) format, VP8 format, or any other video encoding format.

CPU 124 prepares the encoded video stream for transmission, which is passed along to NIC 122. NIC 122 includes circuitry necessary for communicating over network 110 via a networking protocol such as Ethernet, Wi-Fi or Internet Protocol (IP). NIC 122 provides the physical layer and the basis for the software layer of server 120's network interface.

Client 140 receives the transmitted video stream for display. Client 140 can be a variety of personal computing devices, including: a desktop or laptop personal computer, a tablet, a smart phone or a television. Client 140 includes a NIC 142, a decoder 144, a video renderer 146, a display 148 and a CPU 150. NIC 142, similar to NIC 122, includes circuitry necessary for communicating over network 110 and provides the physical layer and the basis for the software layer of client 140's network interface. The transmitted video stream is received by client 140 through NIC 142. CPU 150 unpacks the received video stream and prepares it for decoding.

The video stream is then decoded by decoder 144. Decoder 144 should match encoder 136, in that each should employ the same formatting or compression scheme. For instance, if encoder 136 employs the ITU-T H.264 standard, so should decoder 144. Decoding may be carried out by either a client CPU or a client GPU, depending on the physical client device. Once decoded, all that remains in the video stream are the raw rendered frames. The rendered frames are processed by a basic video renderer 146, as is done for any other streaming media. The rendered video can then be displayed on display 148.

Having described a server-client remote graphics processing system within which the graphics server and method for managing streaming parameters may be embodied or carried out, various embodiments of the graphics server and method will be described.

FIG. 2 is a block diagram of one embodiment of a graphics server 200, such as server 120 of FIG. 1. Graphics server 200 includes NIC 122, CPU 124 and GPU 130, all of FIG. 1. Additionally, graphics server 200 includes a real-time bandwidth estimator (RBE) 210 and a QoS manager 220. GPU 130 includes graphics renderer 132, frame capturer 134 and encoder 136, also of FIG. 1.

As in server 120 of FIG. 1, basic operation of graphics server 200 includes rendering a scene, capturing frames and encoding frames for subsequent transmission to a client. CPU 124 executes an application by which it generates rendering commands and either generates, or recalls from memory, scene data for rendering. Graphics renderer 132 carries out the rendering commands on the scene data to produce a rendered scene having a resolution. Frame capturer 134 and encoder 136 are configured to operate at a frame rate specified by CPU 124. Not only is the frame rate the rate at which frames of rendered content are captured and encoded, but also transmitted, and likely decoded and displayed. Such an arrangement is sensitive to latency and sub-optimal network conditions. Frame capturer 134 “captures” rendered content by periodically copying the rendered content into a staging buffer in memory. Encoder 136 gains access to the staging buffer in memory and encodes the stored frame. A variety of encoding schemes could be used by encoder 136, including h.264, WMV and MPEG-4. Encoder 136 operates at both a frame rate and a bit rate. The frame rate specifies the number of frames encoder 136 encodes in a given period of time, similar to frame capturer 134. The bit rate specifies the number of bits allocated for encoding each frame. The combination of the frame rate and bit rate translates to the rate at which data is transmitted over a network via NIC 122, otherwise known as the data rate, or streaming bit rate.

CPU 124 retrieves encoded frames from memory “packs” them for transmission via NIC 122. This preparation typically involves packetizing the data from the frame buffer and possibly additional encoding for the transmission protocol.

RBE 210 monitors network congestion via NIC 122 and generates a bandwidth estimation based on data such as number of retries and wait time. In certain embodiments, RBE 210 is built into NIC 122. There are a variety of methods of performing real-time bandwidth estimation; which method is used is typically at the discretion of device and chip manufacturers for a particular network interface. For example, certain embodiments use a Wi-Fi chipset as part of the network interface. A manufacturer of Wi-Fi chipsets may select one bandwidth estimation method over another for a variety of reasons.

Continuing the embodiment of FIG. 2, QoS manager 220 receives the bandwidth estimation from RBE 210 and uses it to generate streaming parameters. The bandwidth estimation provided by RBE 210 could be as simple as a binary assessment: the network has excess bandwidth or the network is short on bandwidth. More sophisticated RBE implementations may be more quantitative, but it is not necessary for the purposes of QoS manager 220. When the bandwidth estimation indicates bandwidth is scarce, QoS manager 220 takes steps to reduce the bandwidth necessary to transmit the rendered scene via streaming parameters. For example, QoS manager 220 can reduce the resolution, reduce the frame rate, reduce the bit rate, or any combination of the three. Additionally, QoS manager 220 can manipulate any other streaming parameters to affect the bandwidth demand. It is often the case that streaming parameters are modified in groups, or are binned to guard against poor combinations that disrupt the streaming experience. For example, as resolution increases, the necessary bit rate to maintain the same fidelity also increases. Likewise, increasing bit rate while holding resolution steady will result in diminishing fidelity gains.

FIG. 3 is a flow diagram of one embodiment of a method of managing streaming parameters for transmitting a rendered scene over a network. The method begins in a start step 310. In a QoS management step 320, a real-time bandwidth estimate for the network is used to determine streaming parameters that effect bandwidth demand. The bandwidth estimate is made without client feedback and is often a capability built into the network controller, such as a Wi-Fi chipset. The bandwidth estimate is made continuously as data is transmitted over the network.

Streaming parameters can be a variety of settings for a particular video stream and are generally carried out by a GPU on the server. Streaming parameters include resolution, frame rate, bit rate and others. In a rendering step 330, the scene is rendered at a resolution determined in QoS management step 320. Frames of the rendered scene are captured at a frame rate, also determined in QoS management step 320, in a capture step 340. In an encode step 350, the captured frames from capture step 340 are encoded at a bit rate determined in QoS management step 320. Then, in a transmit step 360, the encoded frames from encode step 350 are packetized and transmitted over the network. Packetizing and transmission can include additional encoding or formatting of the encoded frames for a particular network protocol. For example, formatting for transmission over a Wi-Fi network. For a complete segment of video, the method is repeated as real-time bandwidth estimates are continuously produced and streaming parameters occasionally adjusted. The method ends in an end step 370.

Those skilled in the art to which this application relates will appreciate that other and further additions, deletions, substitutions and modifications may be made to the described embodiments.

What is claimed is:

1. A graphics server, comprising:
a real-time bandwidth estimator (RBE) configured to generate a bandwidth estimate for a network over which a rendered scene is transmittable;
a quality-of-service (QoS) manager configured to generate streaming parameters based on said bandwidth estimate; and
a graphics processing unit (GPU) configured to employ said streaming parameters to at least partially prepare said rendered scene for transmission.

2. The graphics server recited in claim 1 wherein said GPU includes a graphics renderer operable to render said rendered scene.

3. The graphics server recited in claim 2 wherein said streaming parameters include a resolution at which said graphics renderer renders said rendered scene.

4. The graphics server recited in claim 1 wherein said GPU includes a frame capturer configured to capture frames of said rendered scene and an encoder configured to encode said frames for subsequent transmission.

5. The graphics server recited in claim 4 wherein said streaming parameters include a frame rate at which said frame capturer captures frames.

6. The graphics server recited in claim 4 wherein said streaming parameters include a bit rate at which said encoder encodes said frames.

7. The graphics server recited in claim 1 wherein said QoS manager generates said streaming parameters such that bandwidth consumption is reduced if said bandwidth estimate indicates a bandwidth shortage.

8. A method of managing streaming parameters for transmitting a rendered scene over a network, comprising:
employing a real-time bandwidth estimate for said network in determining said streaming parameters;
preparing said rendered scene according to said streaming parameters; and
packetizing and transmitting said rendered scene over said network.

9. The method recited in claim 8 wherein said preparing includes:
rendering said rendered scene;
capturing frames of said rendered scene; and
encoding said frames.

10. The method recited in claim 9 wherein said streaming parameters include:
a resolution at which said rendered scene is rendered;
a frame rate at which said frames are captured; and
a bit rate at which said frames are encoded.

11. The method recited in claim 10 wherein said resolution is reduced if said real-time bandwidth estimate indicates a bandwidth shortage, thereby providing a good streaming experience.

12. The method recited in claim 10 wherein said frame rate is reduced if said real-time bandwidth estimate indicates a bandwidth shortage, thereby providing a good streaming experience.

13. The method recited in claim 10 wherein said bit rate is increased if said real-time bandwidth estimate indicates additional bandwidth is available, thereby providing a good streaming experience.

14. The method recited in claim 8 wherein said packetizing and transmitting includes formatting encoded frames for transmission over a Wi-Fi network.

15. A graphics server, comprising:
a communication subsystem having:
a network interface controller (NIC) couplable to a network and operable to transmit packets describing a rendered scene over said network, and
a real-time bandwidth estimator (RBE) coupled to said NIC and configured to generate a bandwidth estimate for said network;
a quality-of-service (QoS) manager configured to generate streaming parameters based on said bandwidth estimate; and
a graphics processing unit (GPU) having:
a graphics renderer operable to render said rendered scene according to said streaming parameters,
a frame capturer configured to capture frames of said rendered scene according to said streaming parameters, and
an encoder configured to encode said frames according to said streaming parameters, thereby preparing said rendered scene for packetizing and transmission.

16. The graphics server recited in claim 16 wherein said network is a Wi-Fi network.

17. The graphics server recited in claim 15 wherein said graphics server is a mobile computing device.

18. The graphics server recited in claim 15 wherein said encoder is an h.264 encoder.

19. The graphics server recited in claim 15 wherein said QoS manager is further configured to select a streaming parameter bin based on said real-time bandwidth estimate.

20. The graphics server recited in claim 15 wherein said QoS manager is further configured to employ minimum values for said streaming parameters to establish a floor on transmitted scene fidelity.
